(19) United States
(12) Patent Application Publication
(10) Pub. No.: US 2014/0162644 A1
(43) Pub. Date: Jun. 12, 2014

(54) METHOD AND APPARATUS FOR PROXIMITY SERVICE ENHANCEMENT IN A WIRELESS COMMUNICATION SYSTEM

(71) Applicant: INNOVATIVE SONIC CORPORATION, Taipei City (TW)

(72) Inventor: Meng-Hui Ou, Taipei City (TW)

(73) Assignee: INNOVATIVE SONIC CORPORATION, Taipei City (TW)

(21) Appl. No.: 14/101,868

(22) Filed: Dec. 10, 2013

Related U.S. Application Data
(60) Provisional application No. 61/735,969, filed on Dec. 11, 2012.

(51) Int. Cl. H04W 60/04

(52) U.S. Cl. CPC H04W 60/04
USPC 455/435.1

(57) ABSTRACT

A method and apparatus are disclosed to provide proximity service discovery in a wireless communication system. The method includes transmitting, from a first user equipment (UE), a message indicating a presence of the first UE to a serving cell or evolved Node B (eNB) when the first UE wants to be discovered.

### CROSS-REFERENCE TO RELATED APPLICATIONS

The present Application claims the benefit of U.S. Provisional Patent Application Ser. No. 61/735,969 filed on Dec. 11, 2012, the entire disclosure of which is incorporated herein by reference.

### FIELD

This disclosure generally relates to wireless communication networks, and more particularly, to methods and apparatuses for proximity service enhancement in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed to provide proximity service discovery in a wireless communication system. The method includes transmitting, from a first user equipment (UE), a message indicating a presence of the first UE to a serving cell or evolved Node B (eNB) when the first UE wants to be discovered.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a block diagram of a direct mode data path in the Evolved Packet System (EPS) for communication between two UEs.

FIG. 6 is a block diagram of a locally-routed data path in the EPS for communication between two UEs when the UEs are served by the same eNB.

FIG. 7 is an exemplary block diagram of a control path for network supported Proximity Services (ProSe) communication for UEs served by the same eNB.

FIG. 8 is a signaling flow diagram according to one exemplary embodiment.

FIG. 9 is a flow diagram according to one exemplary embodiment.

FIG. 10 is a flow diagram according to one exemplary embodiment.

FIG. 11 is a flow diagram according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. SP-110638, “WID on Proposal for a study on Proximity-based Services,” TR 23.803-100, “Feasibility Study for Proximity Services (ProSe),” TS 36.331 V11.1.0, “E-UTRA RRC protocol specification (Release 11)”, and U.S. Department of Commerce Document No. RWS-120033, “Public Safety Requirements for Long Term Evolution REL-12.” The standards and documents listed above are hereby expressly incorporated by reference in their entirety.

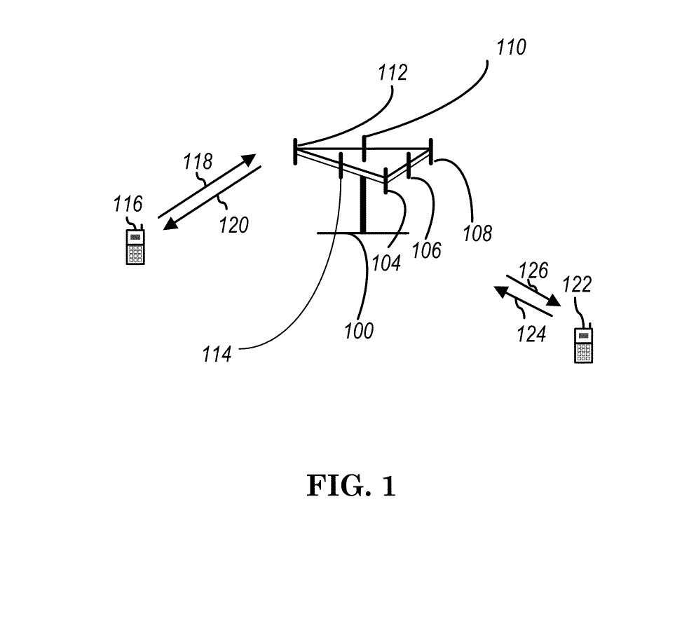

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

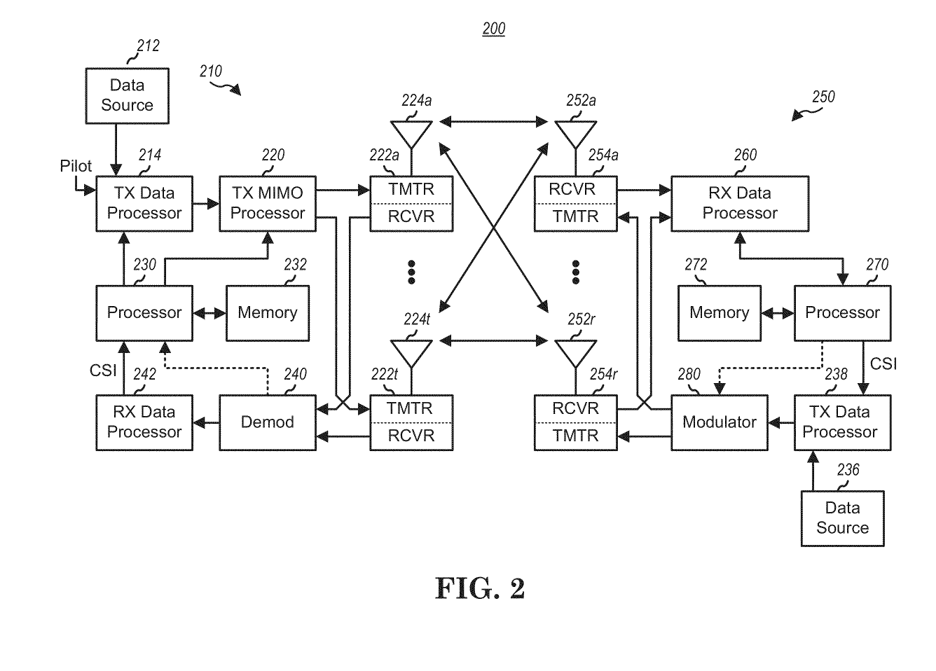

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

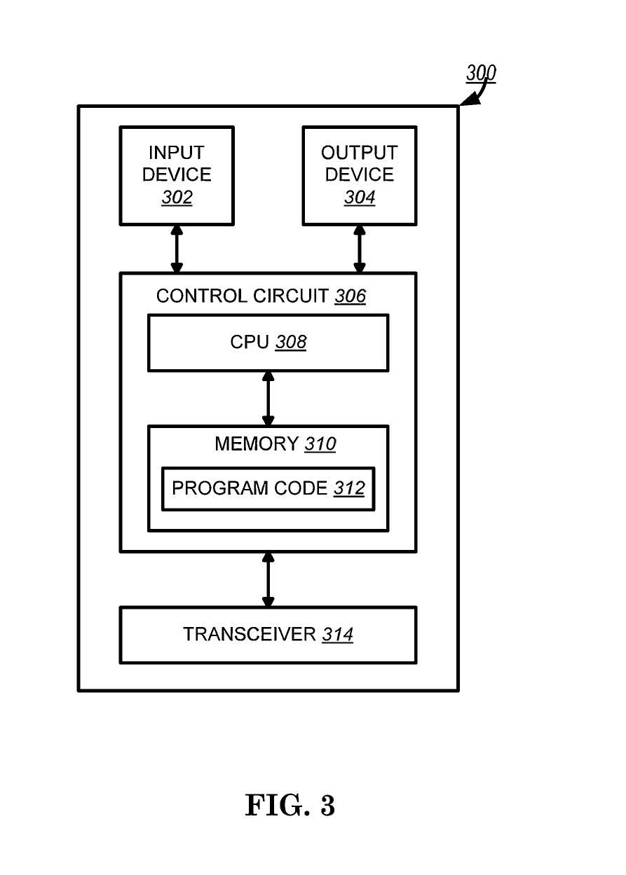

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

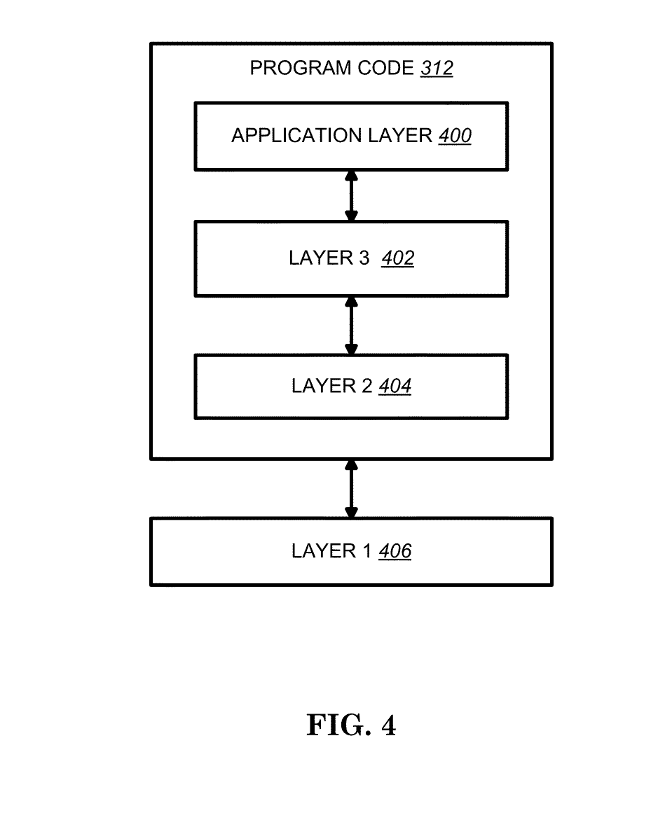

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE or LTE-A systems, the Layer 2 portion may include a Radio Link Control (RLC) layer and a Medium Access Control (MAC) layer. The Layer 3 portion may include a Radio Resource Control (RRC) layer.

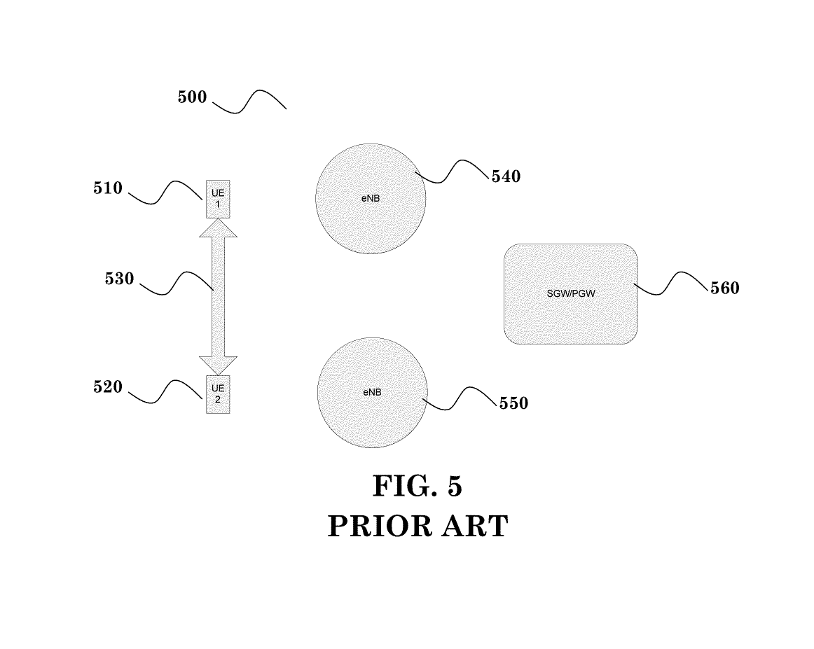

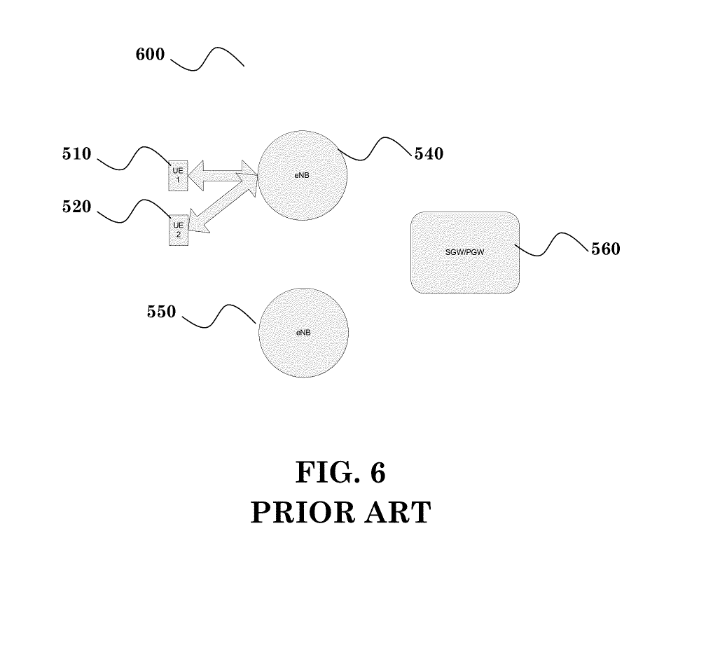

FIGS. 5 and 6 illustrate possible data paths for ProSe Communications. FIG. 5 illustrates a direct mode data path in the Evolved Packet System (EPS) for communication between two UEs 510, 520 in a system 500 is composed of two UEs 510, 520, two evolved Node B's (eNBs) 540, 550 and a serving gateway and/or packet data network gateway (SGW/PGW) 560. FIG. 6 illustrates a locally-routed data path in the EPS for communication between two UEs 510, 520 when the UEs are served by the same eNB 540. In FIG. 6, the system 600 may be composed of two UEs 510, 520, two eNBs 540, 550, and a SGW/PGW 560.

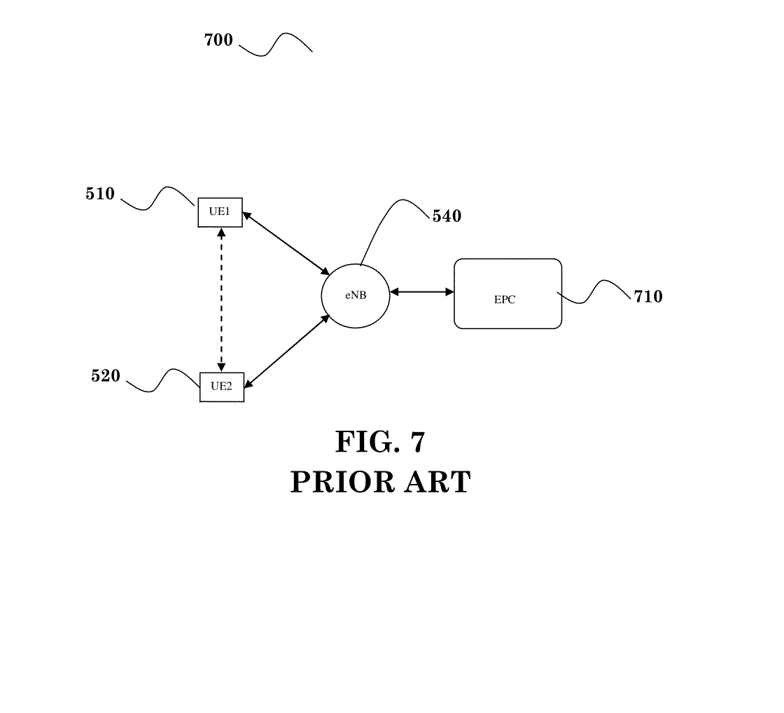

FIG. 7 illustrates a possible control path for ProSe Communications. As shown in FIG. 7, UEs 510, 520 are served by the same eNB 540. The UEs 510, 520 communicate with the same eNB 540, which in turn communicates with an Evolved Packet Core (EPC) 710.

3GPP SP-110638 proposes a new study item on proximity-based services (ProSe). The justification and objective of this study item are quoted below:

Justification
Proximity-based applications and services represent a recent and enormous socio-technological trend. The principle of these applications is to discover instances of the applications running in devices that are within proximity of each other, and ultimately also exchange application-related data. In parallel, there is interest in proximity-based discovery and communications in the public safety community.
Current 3GPP specification are only partially suited for such needs, since all such traffic and signalling would have to be routed in the network, thus impacting their performance and adding un-necessary load in the network. These current limitations are also an obstacle to the creation of even more advanced proximity-based applications.
In this context, 3GPP technology, has the opportunity to become the platform of choice to enable proximity-based discovery and communication between devices, and promote a vast array of future and more advanced proximity-based applications.

4 Objective
The objective is to study use cases and identify potential requirements for an operator network controlled discovery and communications between devices that are in proximity, under continuous network control, and are under a 3GPP network coverage, for:
   1. Commercial/social use
   2. Network offloading
   3. Public Safety
   4. Integration of current infrastructure services, to assure the consistency of the user experience including reachability and mobility aspects
Additionally, the study item will study use cases and identify potential requirements for
   5. Public Safety, in case of absence of EUTRAN coverage (subject to regional regulation and operator policy, and limited to specific public-safety designated frequency bands and terminals)

Use cases and service requirements will be studied including network operator control, authentication, authorization, accounting and regulatory aspects.

The study does not apply to GERAN or UTRAN.

3GPP TR 22.803-100 Captures the feasibility study for proximity-based services (ProSe). It defines three categories of communications for public safety service and also describes public safety use of ProSe as quoted below:

### 3.1 Definitions

ProSe Communication: a communication between two UEs in proximity by means of a communication path established between the UEs. The communication path could for example be established directly between the UEs or routed via local eNB(s).
ProSe Group Communication: a one-to-many ProSe Communication, between two or more UEs in proximity, by means of a common communication path established between the UEs.
ProSe Broadcast Communication: a one-to-all ProSe Communication, between all authorized UEs in proximity, by means of a common communication path established between the UEs.

4.3 Public Safety Use of ProSe
In the United States, LTE has been selected by the FCC as the technology [2] [3] [4] for the Public Safety Network. In Europe, there is an ongoing discussion on spectrum to be chosen for broadband Public Safety held by CEPT ECC WG FM PT 49 [8]. Additionally, a variety of public safety over ProSe requirements have been defined [5] [6] [7]. The requirements raise the following points for consideration in developing the ProSe requirements for public safety use.
A public safety UE can operate in the public safety spectrum for public safety service and in the MNO commercial spectrum, for general service (e.g. voice call), however, only the public safety spectrum is used for public safety ProSe.
Public safety UEs using ProSe communicate with each other even though they belong to different HPLMNs.
A public safety UE can automatically use ProSe when network coverage is not available, or the user can manually set the UE to use direct discovery and communication even when network coverage is available.
In addition, the following assumptions are made for public safety ProSe:
   All public safety users utilize ProSe-enabled UEs
   ProSe supports both UE discovery and data exchange
If and when other regional and/or regulatory requirements are raised, they will be taken into account.

Additionally, 3GPP TR 22.803-100 also describes the public safety use cases of group communication and relay communication in ProSe as quoted below:

5.2.7 ProSe Group

5.2.7.1 Description
This use case describes the scenario where a user wants to communicate the same information concurrently to two or more other users using ProSe Group Communications. The UEs of all users in the scenario belong to a common communications group.

5.2.7.2 Pre-Conditions
An operator offers a service, which makes use of the ProSe feature.
Officer A, Officer B, and Officer C use ProSe-enabled public safety UEs.
Officer A, B, and C's UEs are configured to belong to communications group X.
Officer C has disabled ProSe Discovery on his/her UE.
Officer A, Officer B, and Officer C are subscribed to a Public Safety service that allows them to use ProSe.
Officer A's UE has discovered Officer B's UE via ProSe Discovery.
Officer A's UE has not discovered Officer C's UE via ProSe.

5.2.7.3 Service Flows
Officer A's UE transmits data using ProSe Group Communications to Officer B and Officer C's UEs concurrently.

5.2.7.4 Post-Conditions
None. 5.2.7.5 Potential Requirements
A Public Safety UE shall be capable of transmitting data to a group of Public Safety UEs using ProSe Group Communications with a single transmission, assuming they are within transmission range and authorized.
A Public Safety UE shall be capable of transmitting data to a group of Public Safety UEs directly using ProSe Group Communications.
A Public Safety UE shall be capable of receiving a ProSe Group Communications transmission, of which it is a group member, regardless of whether or not it has been discovered by the transmitting UE.
Group management is outside the scope of ProSe.
[ . . . ]

5.2.9 ProSe Relay

5.2.9.1 Description
This use case describes the scenario where a given UE acts as a communication relay for one or more UEs.

5.2.9.2 Pre-Conditions
An operator offers a service, which makes use of the ProSe feature.
Officer A, Officer B, and Officer C use ProSe-enabled public safety UEs.
Officer B's UE has a relay capability allowing it to receive and re-transmit ProSe Communications.
Officer A, Officer B, and Officer C are subscribed to a Public Safety service that allows them to use ProSe.
Officer A's UE, Officer B's UE, and Officer C's UE have each been configured to belong to communications group X.
Officer A's UE is within transmission range of Officer B's UE, and Officer B's UE is within transmission range of Officer C's UE, but Officer C's UE is not within transmission range of Officer A's UE.

5.2.9.3 Service Flows
Officer A wants to communicate with Officer B and Officer C in communications group X via ProSe Group Communications.
Officer B enables his/her UE to act as a relay for ProSe Group Communications.
Officer A's UE transmits a message to Officer B's UE using ProSe Group Communications.
Officer B's UE relays (receives and then re-transmits) the communication from Officer A's UE to Officer C's UE, all using ProSe Group Communications.
Officer B continues to act as a ProSe Group Communications relay until Officer C is back within transmission range of Officer A and Officer B.

5.2.9.4 Post-Conditions
None.

5.2.9.5 Potential Requirements
An authorized public safety UE may be capable of acting as a relay for other public safety UEs.
An authorized public safety UE shall be capable of being enabled/disabled by a user or system to act as a relay for other public safety UEs.
The user of a ProSe-enable public safety UE acting as a relay should not perceive service degradation due to the relay.

In the wireless communication technology, there are methods for peer-to-peer connections gaining radio resources for data transfer on a connection scheduling channel. Typically, a traffic control channel (TCCH) includes a connection scheduling channel. The connection scheduling channel may be further divided into subchannels for connection scheduling, rate scheduling, data segment, and acknowledgement. These subchannels may be further subdivided into blocks. The blocks may be high and low priority, contain resource elements (such as subcarriers in the frequency domain and Orthogonal Frequency Division Multiplexing symbols in the time domain). In one connection scheduling signaling scheme, a priority scheme based on the medium access priority of each link is utilized.

Currently, the ProSe discovery is achieved by the UE to be discovered transmitting some kind of beacon signal, e.g. the proximity detection signal, which is monitored by the UE that is attempting to discover other UEs in its vicinity. However, this kind of direct peer-to-peer ProSe discovery can only discover the UE in the range of direct communication while ProSe communication can be direct mode or locally-routed mode. If the ProSe discovery can be extended to detect the UE which is beyond the range of the direct peer-to-peer discovery, ProSe communication, e.g. using locally-routed mode, can be improved to support the communication between the UEs beyond the range of direct communication.

In order to support a longer range of ProSe communication, e.g. using locally-routed mode, the ProSe discovery needs to be improved so that the range of discovery can exceed the range of the direct peer-to-peer discovery.

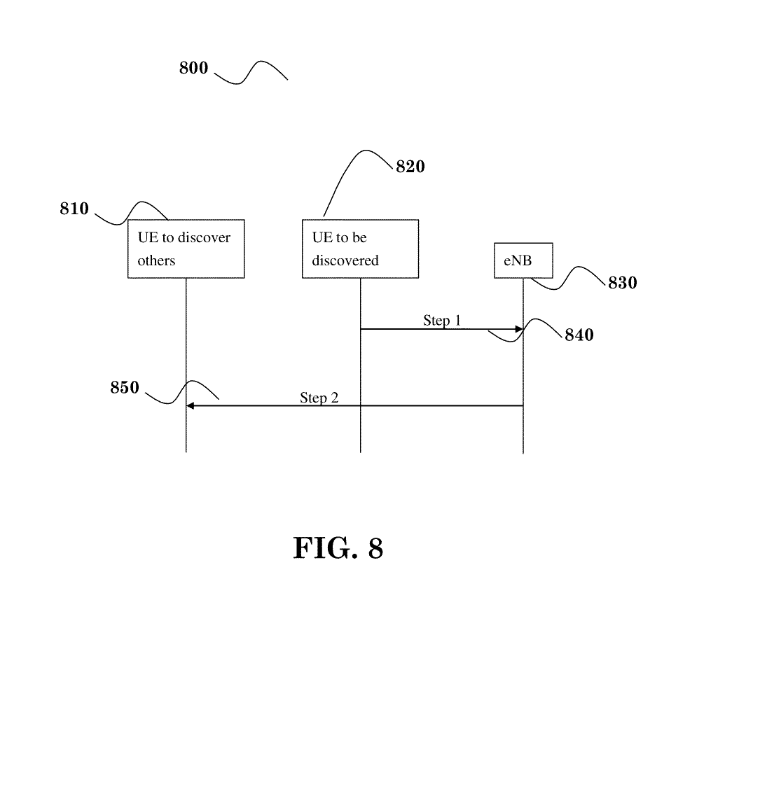

FIG. 8 illustrates a signal flow of some embodiments for ProSe discovery. In one embodiment, as shown in FIG. 8, a UE 820 attempting to be discovered indicates its presence to an eNB 830 (or alternatively a serving cell (not shown)) at step 840. In another embodiment, the eNB 830, at step 850 transmits a message to another UE 810 indicating that UE 820 is to be discovered.

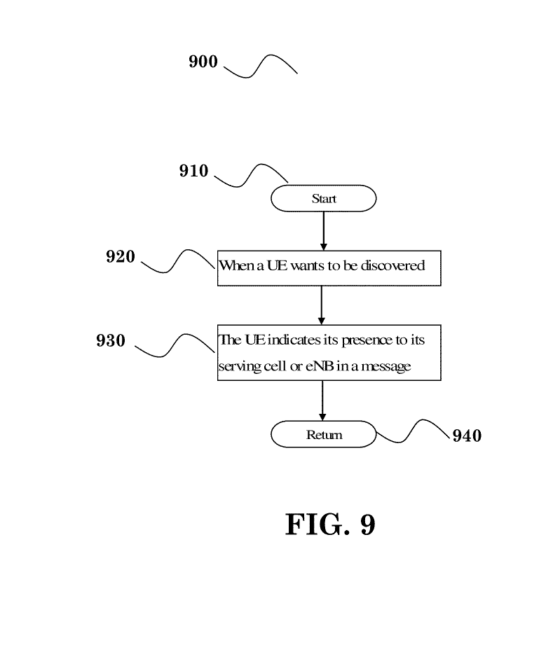

FIG. 9 illustrates one embodiment of a UE indicating its presence to a serving cell or eNB. At step 910, the discovery process is initiated. At step 920, a UE determines that it wants to be discovered. At step 930, the UE attempting to be discovered indicates its presence (at step 930) to its serving cell or eNB. The indication may be transmitted periodically. The indication may indicate that the UE is allowed to be discovered. Alternatively, the indication may indicate that the UE allows locally-routed communication. The indication message sent to the serving cell or eNB may include one or more of the following: the identity of the UE; the identity of the UE used for proximity service; the identity of the service and/or application offered and/or requested by the UE; and the description and/or characteristics about the service and/or application offered and/or requested by the UE. In another embodiment, information relating to the status of the UE such as, but not limited to, speed, location, or measurement result, may also be provided to the serving cell or eNB. In another embodiment, the information may be specific to a range of classes.

In another embodiment, a UE may acquire information from a cell or eNB wherein the information is about UE(s) in the proximity. The information may be about the UE(s) to be discovered in the proximity. Alternatively, the information may be about the UE(s) to be discovered in the coverage of the cell or eNB. The information may be broadcasted (e.g. in system information) or dedicated to the UE (e.g. in a dedicated signaling). The information may be used for open ProSe discovery or restricted ProSe discovery. The information may include one or more of the following: the identity of the UE(s) in the proximity; the identity of the UE(s) used for proximity service, the identity of the service and/or application offered and/or requested by the UE(s) that can be discovered in the proximity; or the description and/or characteristics about the service and/or application offered and/or requested by the UE(s) that can be discovered in the proximity. The information may be specific to one or more range classes.

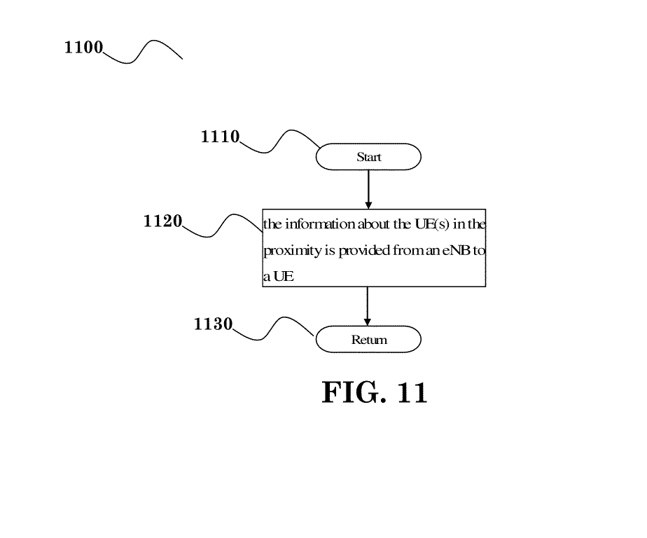

FIG. 11 illustrates one embodiment of an eNB or serving cell providing information about the UE(s) in the proximity of a UE. At step 1110, the method is initiated. At step 1120, the information about the UE(s) in the proximity is provided by the eNB or serving cell. The information may be about the UE(s) to be discovered in the proximity. Alternatively, the information may be about the UE(s) to be discovered in the coverage of the cell or eNB. In one embodiment, the UE information may be broadcasted (e.g. in system information) or dedicated to the UE. In another embodiment, the UE information may be used for open ProSe discovery or restricted ProSe discovery. The information about the UE may include one or more of the following: the identity of the UE(s); the identity of the UE(s) used for proximity service; the identity of the service and/or application offered and/or requested by the UE(s) that can be discovered in the proximity; or the description and/or characteristics about the service and/or application offered and/or requested by the UE(s) that can be discovered in the proximity. The information may be specific to one or more range classes.

In one embodiment, after ProSe discovery, a UE may attempt to communicate with a peer UE using locally-routed ProSe communication. The UE obtains the proximity information for the peer UE it wants to communicate with. The UE will then attempt to detect the peer UE. In the event that the UE cannot detect the peer UE, the UE can send a request to the eNB to initiate the locally-routed ProSe communication. The eNB can establish the communication between the UE and the peer UE. In another embodiment, the eNB may also query the peer UE whether to accept the request before establishing the communication.

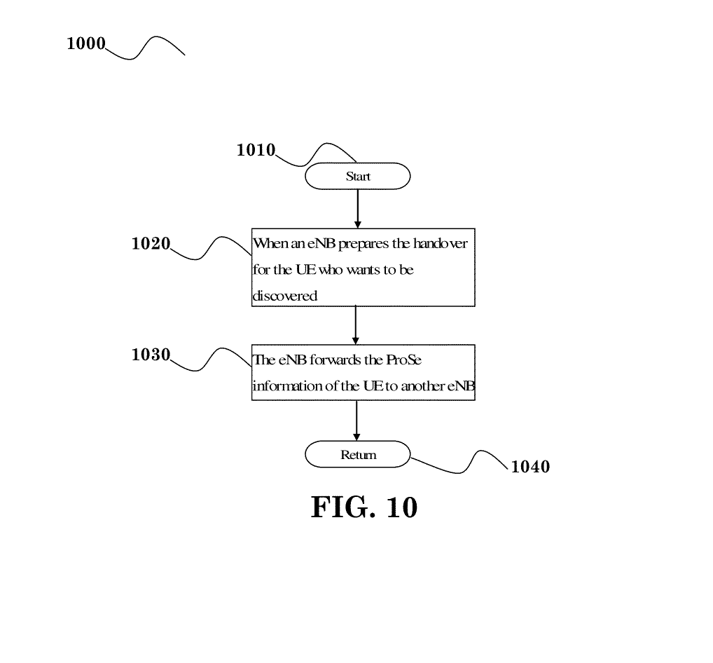

Referring back to FIG. 10, one embodiment of a method of maintaining ProSe information during handover preparation is shown. At step 1010, the method is initiated. At step 1020, an eNB prepares handover for a UE that is attempting to be discovered. At step 1030, the eNB forwards the ProSe information of the UE to another eNB. In one embodiment, the ProSe information of the UE is included in the handover preparation information message. The ProSe information may be specific to one or more range classes.

In one embodiment, the indicating the presence of a UE to be discovered is triggered when the UE transmits a proximity detection signal. The transmission of the proximity detection signal may be the first time when the UE is in the coverage area of a serving cell of eNB. The proximity detection signal is transmitted so that UEs in the surrounding area may discover the UE. In another embodiment, the indication is triggered when the UE returns from out-of-coverage (and still wants to be discovered). In yet another embodiment, the UE stops providing the indication when the UE does not want to be discovered. Alternatively, the UE may provide an indication (e.g. for cancellation) that it does not want to be discovered.

In another embodiment, the indication is included in a response message of the message to enable or activate the feature of ProSe. In another embodiment, the indication is included in a response message of the message providing some configuration information to the UE such as a RRCConnectionReconfigurationComplete message, RRCConnectionSetupComplete message, RRCConnectionReestablishmentComplete message, or the like. In one embodiment, the indication is included in a request message of the UE, such as a RRCConnectionRequest message, RRCConnectionReestablishmentRequest message, or the like. In other embodiments, the indication is provided with a message providing UE assistance information or a message providing ProSe assistance information.

In other embodiments, the UE is ProSe enabled. The UE may be in connected mode. The UE is authorized and/or authenticated for using proximity services, such as ProSe discovery or ProSe communication.

Referring back to FIGS. 3 and 4, the device 300 includes a program code 312 stored in memory 310. In one embodiment, the CPU 308 could execute the program code 312 (i) to transmit a message indicating a presence of the UE to a serving cell or evolved Node B (eNB) when the UE wants to be discovered.

In another embodiment, the CPU 308 could execute program code 312 to execute one or more of the following: (i) to broadcast a proximity detection signal, (ii) to transmit a cancellation message to the serving cell or eNB when the UE does not want to be discovered, (iii) acquire information from the serving cell or eNB about the UE in the proximity, (iv) to receive information from the serving cell or eNB about a second UE in the proximity.

In yet another embodiment, the CPU 308 could execute the program code 312 to prepare a handover for a user equipment (UE), and (ii) to forward proximity service (ProSe) information of the UE to another eNB when preparing a handover for the UE.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for proximity service discovery in a wireless communication system, the method comprising:
transmitting, by a first user equipment (UE), a message indicating a presence of the first UE to a serving cell or evolved Node B (eNB) when the first UE wants to be discovered.

2. The method of claim 1, wherein the message further indicates that the first UE allows itself to be discovered in a proximity service (ProSe) discovery process.

3. The method of claim 1, wherein the message is transmitted when the first UE transmits a proximity detection signal.

4. The method of claim 3, wherein the proximity detection signal is transmitted for a first time when the first UE is in the coverage of the serving cell or eNB.

5. The method of claim 1, wherein the message is transmitted when the first UE returns from out-of-coverage.

6. The method of claim 1, further comprising: transmitting, from the first UE, a cancellation message to the serving cell or eNB when the first UE does not want to be discovered.

7. The method of claim 1, wherein the message is a message providing UE assistance information, a message providing ProSe assistance information, or a response message of the message to enable or activate a feature of ProSe.

8. The method of claim 1, wherein the message further includes the identity of the first UE, the identity of the first UE used for proximity service, the identity of a service or application offered or requested by the first UE, the description or characteristics about the service or application offered or requested by the first UE, speed of the first UE, location of the first UE, a measurement result of the first UE.

9. The method of claim 1, further comprising: acquiring, by the first UE, information from the serving cell or eNB about one or more UE in the proximity.

10. The method of claim 9, wherein information is about one or more UE to be discovered in the proximity or one or more UE in the coverage of the cell or eNB.

11. The method of claim 10, wherein the information is provided in system information or a dedicated signaling message.

12. A method for providing proximity service in a wireless communication system, the method comprising:
preparing, by a first evolved Node B (eNB), a handover for a user equipment (UE); and
forwarding proximity service (ProSe) information of the UE to a second eNB.

13. The method of claim 12, wherein the ProSe information includes an indication that the UE wants to be discovered in a ProSe discovery process, the identity of the UE, the identity of the UE used for proximity service, the identity of a service or application offered or requested by the UE, or the description or characteristics about the service or application offered or requested by the UE.

14. The method of claim 12, wherein the ProSe information of the UE is included in handover preparation information message.

15. A user equipment (UE) for proximity service discovery, the UE comprising:
a control circuit;
a processor installed in the control circuit;
a memory installed in the control circuit and operatively coupled to the processor;
wherein the processor is configured to execute a program code stored in memory to:
transmit a message indicating a presence of the UE to a serving cell or evolved Node B (eNB) when the UE wants to be discovered.

16. The user equipment of claim 15, wherein the message further includes the identity of the UE, the identity of a service or application offered or requested by the UE, the description or characteristics about the service or application offered or requested by the UE, speed of the UE, location of the UE, or a measurement result of the UE.

17. The user equipment of claim 15, wherein the program code further includes code to transmit a cancellation message to the serving cell or eNB when the UE does not want to be discovered.

18. The user equipment of claim 15, wherein the program code further includes code to acquire information from the serving cell or eNB about any UE in the proximity.
